(19) United States
(12) Patent Application Publication
(10) Pub. No.: US 2026/0024067 A1
(43) Pub. Date: Jan. 22, 2026

(54) ITEM IDENTIFICATION IN AN IMAGE BY A VISUAL IDENTIFICATION MODEL TRAINED USING INFORMATION FROM AN ITEM SCANNER SYSTEM

(71) Applicant: DRAGONFRUIT Al, INC., Menlo Park, CA (US)

(72) Inventor: Amit Kumar, Menlo Park, CA (US)

(21) Appl. No.: 18/779,845

(22) Filed: Jul. 22, 2024

(51) Int. Cl. G06Q 20/20; G06V 20/52

(52) U.S. Cl. CPC G06Q 20/208; G06V 20/52; G06T 2207/20132; G06V 2201/07

(57) ABSTRACT

The technology disclosed herein enables identification of items in an image using a machine learning model that is automatically trained using information captured by a scanner system. In a particular example, a method includes receiving an image captured at a capture time of a checkout space including a scanner system and receiving an indication that an item has been scanned by the scanner system. The indication includes an identity of the item and identifies a scan time when the item was scanned. The method also includes correlating the scan time with the capture time and providing the image and the identity of the item to a visual identification model to train the visual identification model to identify the item from other images.

### BACKGROUND

Training machine learning models for identifying objects captured in images or videos typically involves several key steps and techniques. Initially, a dataset of annotated images is gathered with each image being labeled with the objects contained therein and indications of where those objects are located. This dataset serves as the foundation for training the model.

The training process usually begins by feeding batches of these annotated images into the model. Through a process called forward propagation, the model makes predictions about the objects present in each image. These predictions are then compared to the ground truth labels using a loss function, which quantifies the difference between predicted and actual outputs. During backpropagation, this loss is used to adjust the model's internal parameters, such as weights and biases, aiming to minimize the error and improve accuracy. This iterative process continues across many epochs, gradually fine-tuning the model's ability to recognize objects by learning from the patterns present in the training data. Once trained, the model may then be evaluated on a separate validation dataset to assess its performance and fine-tuned further as needed to achieve desired levels of accuracy and generalization.

Gathering the annotated dataset and providing the annotations can be very time consuming. For example, if a model is to be used for identifying items in a store, a user may need to annotate images of all the items in the store from different angles before the annotated images are fed into the model for training. Moreover, beyond the initial training on items currently stocked in the store, new items may be brought into the store (e.g., a new product may be released for sale). The model will not be able to identify the new items until the user annotates images of the new items to further train the model. Thus, there may be gaps in information gathered from the model's identification output until the user has time to update the model.

### SUMMARY

The technology disclosed herein enables identification of items in an image using a machine learning model that is automatically trained using information captured by a scanner system. In a particular example, a method includes receiving an image captured at a capture time of a checkout space including a scanner system and receiving an indication that an item has been scanned by the scanner system. The indication includes an identity of the item and identifies a scan time when the item was scanned. The method also includes correlating the scan time with the capture time and providing the image and the identity of the item to a visual identification model to train the visual identification model to identify the item from other images.

In another example, a method includes receiving images captured by a plurality of cameras directed towards a plurality of checkout spaces including a plurality of checkout scanners. The method further includes identifying items being scanned in the images from scan information received from the plurality of checkout scanners when the items are scanned. Also, the method includes training a visual identification model to identify the items from subsequent images.

In a further example, an apparatus includes one or more computer readable storage media, a processing system operatively coupled with the one or more computer readable storage media, and program instructions stored on the one or more computer readable storage media. The program instructions, when read and executed by the processing system, direct the apparatus to receive an image captured at a capture time of a checkout space including a scanner system and receive an indication that an item has been scanned by the scanner system. The indication includes an identity of the item and identifies a scan time when the item was scanned. The program instructions further direct the processing system to correlate the scan time with the capture time and provide the image and the identity of the item to a visual identification model to train the visual identification model to identify the item from other images.

### BRIEF DESCRIPTION OF THE DRAWINGS

FIG. 1 illustrates an implementation for identifying an item in an image using a visual identification model trained using scanned information.

FIG. 2 illustrates an operation to identify an item in an image using a visual identification model trained using scanned information.

FIG. 3 illustrates an operation to identify an item in an image using a visual identification model trained using scanned information.

FIG. 4 illustrates an implementation for identifying an item in an image using a visual identification model trained using scanned information.

FIG. 5 illustrates an operational scenario for identifying an item in an image using a visual identification model trained using scanned information.

FIG. 6 illustrates an operational scenario for identifying an item in an image using a visual identification model trained using scanned information.

FIG. 7 illustrates an operational scenario for identifying an item in an image using a visual identification model trained using scanned information.

FIG. 8 illustrates a timeline for identifying an item in an image using a visual identification model trained using scanned information.

FIG. 9 illustrates a location for identifying an item in an image using a visual identification model trained using scanned information.

FIG. 10 illustrates a location for identifying an item in an image using a visual identification model trained using scanned information.

FIG. 11 illustrates a video frame for identifying an item in an image using a visual identification model trained using scanned information.

FIG. 12 illustrates a video frame for identifying an item in an image using a visual identification model trained using scanned information.

FIG. 13 illustrates a location for identifying an item in an image using a visual identification model trained using scanned information.

FIG. 14 illustrates a computing system for identifying an item in an image using a visual identification model trained using scanned information.

### DETAILED DESCRIPTION

Entities, such as retail businesses, leverage machine learning models to perform tasks can improve operational costs and effectiveness. For instance, a business may use cameras to monitor a sales floor for item inventory, item movement, or loss prevention. Instead of a person, or people, viewing video feeds from the cameras, a machine learning algorithm may be trained to identify and track items in the video feeds. Use of the model allows the people who would be viewing the feeds to be assigned to other tasks. Likewise, the model may be capable of tracking metrics that would be difficult or impossible for a person.

However, training the machine learning model also takes time and user interaction. When a user recognizes an item (or items) is not trained into the model for recognition, the user will need to create the annotated training set for the item. The more items that need to be trained into the model, the more user time it will take to create the annotated. In the time before the model is trained on the item, the model will not be able to recognize the item when processing captured images. The image processing systems in the examples below automatically annotate images with item identification information and feed the annotated images into a machine learning model for training. This automatic training reduces or eliminates completely the user time needed to be spent on training and may create more robust training sets from which the model is trained than a user could otherwise produce.

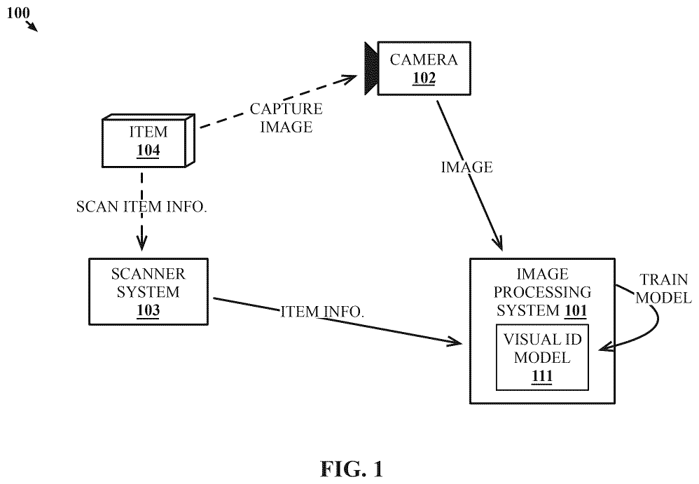

FIG. 1 illustrates implementation 100 for identifying an item in an image using a visual identification model trained using scanned information. Implementation 100 includes image processing system 101, camera 102, scanner system 103, and item 104. Image processing system 101 may communicate with scanner system 103 and camera 102 via direct links (wired or wireless) or over a communication network. The communication network may include one or more Local Area Networks (LANs) and/or one or more Wide Area Networks (WANs), such as the Internet. In some examples, image processing system 101 may be distributed across multiple devices and the devices may be positioned at different geographic locations. For example, at least a portion of image processing system 101 may be a local system at the location of camera 102 and scanner system 103 or may be a cloud-based system remote from the location of camera 102 and scanner system 103.

In operation, image processing system 101 may be configured to process still images or moving images (e.g., video). Image processing system 101 may include a desktop computer, laptop computer, server computer, or some other type of processor-based computing system—including combinations thereof. Camera 102 captures images for processing by image processing system 101. At least a portion of the captured images are used by image processing system 101 to train visual identification model 111, which is a machine learning model image processing system 101 uses to identify items in other images captured by camera 102 or by other cameras connected to image processing system 101. Camera 102 may be a still camera or a video camera. Camera 102 may be a camera dedicated to providing images for training visual identification model 111 or may have additional purposes. For instance, camera 102 may be a camera used for monitoring the goings on at a location that includes scanner system 103 (e.g., camera 102 may be part of a security system at the location).

Scanner system 103 is located within a capture frame of camera 102. Scanner system 103 includes a scanner for scanning item identification information from items presented to scanner system 103. For decades, barcodes are visual labels that have reached almost ubiquitous use to identify items and, more recently, QR codes have enhanced the barcode concept. As such, scanner may be a handheld scanner, a presentation scanner, an in-counter scanners, a fixed mount scanner, or some other type of scanner capable of reading the information coded in a barcode, QR code, or other type of visual coding. Other types of mechanisms for labeling items may also be used, such as Radio Frequency Identification (RFID). In some examples, scanner system 103 may also, or instead, include a scanner, such as an RFID reader, for reading labels for one or more these alternative labelling mechanisms.

Scanner system 103 also includes processing circuitry for determining the identity of items being scanned. For example, a barcode may encode a sequence of numbers and scanner system 103 may reference a data structure, or perform some other type of lookup/query, to determine information about an item corresponding to the sequence (e.g., a name of the item, a price of the item, or some other type of useful information). Scanner system 103 may be a retail checkout system located at a checkout area where customers can bring their items for purchase from a store, may be a price checker system in a store allowing a user to check the price of an item prior to purchase, may be a warehouse inventory scanner, or some other type of system that uses item label information in its normal course of operation.

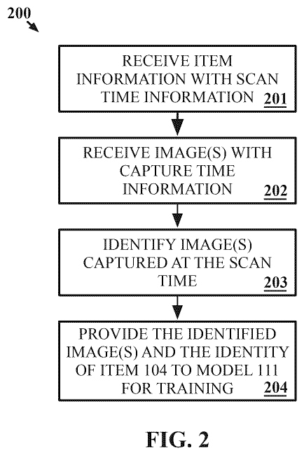

FIG. 2 illustrates operation 200 to identify an item in an image using a visual identification model trained using scanned information. Operation 200 is described with item 104 as an example item (e.g., product or other type of object) that may be scanned by scanner system 103. Items can come in many different shapes, sizes, colors, etc. such that at least one characteristic of item 104 visually distinguishes item 104 from other items. The visual distinction of item 104 may depend on the type of item (e.g., clothing, toy, food, etc.), packaging materials used if any (e.g., plastic, cardboard, wood, cloth, etc.), an item shape, colors used in printed labels, designs on printed labels, or some other characteristic of an object.

In operation 200, image processing system 101 receives item information from scanner system 103 in response to item 104 being scanned by scanner system 103 (step 201). The item information may be sent immediately after scanner system 103 scanned item 104 or may be sent later. For example, scanner system 103 may send item scan information for multiple items in bulk (e.g., hourly, daily, at the end of each transaction, etc.). The item information at least includes an identifier for identifying item 104 that is unique at least among other items that visual identification model 111 may be tasked with identifying. For example, the identifier may include a brand name and product name for item 104. In some cases, the same names may be used for different generations/versions of a product. In those cases, a version number, date (e.g., model year), or other version-differentiating information may be included in the identifier. Alternatively, image processing system 101 may not require that visual identification model 111 distinguish between different generations so version-differentiating information may not be necessary. In some examples, the identifier may not explicitly identify item 104 but, rather, may include an identifier that can be referenced to determine the actual identity of item 104 (e.g., product name, product brand, etc.). In one example, the identifier may be the barcode sequence. In such examples, image processing system 101 may use the identifier to determine the actual identity of item 104 or may provide the identifier to visual identification model 111 as is in step 204 below. The identifier can then be used at a later time to look up what item visual identification model 111 is referring to when the identifier is indicated in output of visual identification model 111.

The item information further includes scan time information, such as a timestamp for when scanner system 103 scanned item 104 (e.g., scanned a barcode or RFID tag on item 104). In some examples, the item information may be sent in real time to image processing system 101 in response to scanning item 104. In those examples, the communication latency between scanner system 103 and image processing system 101 may be considered negligible and image processing system 101 may, therefore, consider the time in which the item information is received to be the time item 104 was scanned.

Image processing system 101 also receives one or more images (still or video) from camera 102 (step 202). In some examples, the images may be received though an intermediate system, such as a camera control system. Since camera 102 captures an area that includes at least the scanner of scanner system 103 in frame, camera 102 captures at least a portion of the one or more images include item 104 when item 104 is scanned. Like the item information, capture time information is included with the images or, if the images are sent to image processing system 101 in real time, image processing system 101 may consider the receipt time of the images to be the capture time. The time information from scanner system 103 indicating when item 104 was scanned and the time information indicating when the images were captured are on the same time scale (e.g., time of day or from the same reference time) such that the scan time and the capture time can be aligned with one another. In examples where both the item information and images are transmitted to image processing system 101 in real time, image processing system 101 may simply associate the received item information with images received from camera 102 at substantially the same time.

Image processing system 101 correlates the scan time with the capture time to identify a portion of the images (e.g., one or more frames of a video) that were captured at the scan time based on the scan time information and the capture time information (step 203). When item 104 was scanned, image processing system 101 can assume item 104 was within a certain distance of the scanner of scanner system 103 (typically no more than a few inches away) such that item 104 will be located nearby the scanner in an image captured at the same time. Image processing system 101 may also identify images captured before and/or after the scan time (e.g., within a second of the scan time) because item 104 may still be nearby the scanner in those images as item 104 is moved toward the scanner for scanning and away from the scanner after scanning. This enables potentially more angles of item 104 to be captured since item 104 may change orientation during movement towards and away from the scanner. In some examples, image processing system 101 may crop the images to include only the area around the scanner in which item 104 is located if the images from camera 102 are framed to capture a wider area. In other examples, visual identification model 111 may be trained to know where items will be located in the image (i.e., near the scanner) to avoid the need for cropping.

Image processing system 101 provides the identified images containing item 104 and the identity of item 104 to visual identification model 111 for training (step 204). Image processing system 101, therefore, effectively annotates the identified images with the identity of the item (i.e., item 104) which visual identification model 111 is being trained to visually identify in future images. Without the item information from scanner system 103, image processing system 101 would be unaware of the identity of item 104 and would be unable to supply that identity to visual identification model 111 for training. By leveraging identity information that was already being determined by scanner system 103 in its normal course of operations (e.g., to scan items in for purchase), image processing system 101 can annotate images captured by camera 102 without explicit user input supplying those annotations.

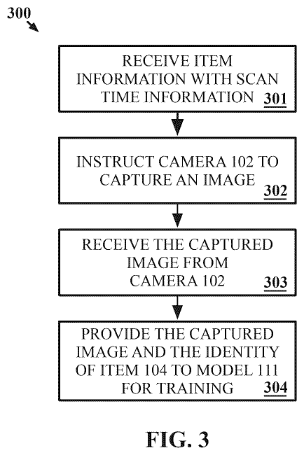

FIG. 3 illustrates operation 300 to identify an item in an image using a visual identification model trained using scanned information. While operation 200 is describes camera 102 as capturing images continually (e.g., a video stream) such that an image is sure to be captured of item 104 when scanned, operation 300 describes an alternative where camera 102 may not be capturing images continually. In operation 300, image processing system 101 receives item information from scanner system 103 similar to that received in operation 200 (step 301). The item information is received in real time in response to item 104 being scanned. Receipt of the item information triggers image processing system 101 to instruct camera 102 to capture an image including the scanner that scanned item 104 (step 302). The latency between item 104 being scanned and camera 102 capturing the image should be low enough that item 104 is still relatively near the scanner when the image is captured. Camera 102 sends the captured image to image processing system 101 after capturing (step 303). In some examples, camera 102 may continually capture images and may only send a captured image to image processing system 101 in response to receiving the instruction from image processing system 101.

Since the item information is sent to image processing system 101 in real time and the image is captured immediately thereafter, image processing system 101 associates the captured image with the item information. The identity of item 104 is provided with the image to visual identification model 111 to train visual identification model 111 to identify item 104 in future images (step 304). Like in operation 200, image processing system 101 in operation 300 may crop the image received from camera 102 to narrow in on the area of the scanner that scanned item 104 if visual identification model 111 is not configured to identify the area on its own.

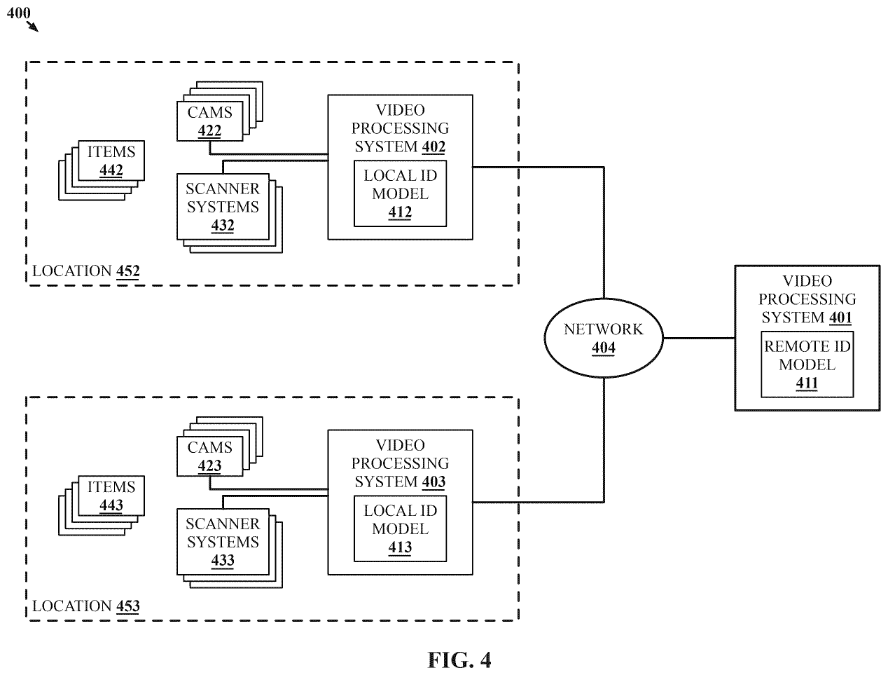

FIG. 4 illustrates implementation 400 for identifying an item in an image using a visual identification model trained using scanned information. Implementation 400 includes video processing systems 401-403, video cameras 422-423, scanner systems 432-433, items 442-443, and network 404. Video processing system 402, video cameras 422, scanner systems 432, and items 442 are located at location 452. Video processing system 403, video cameras 423, scanner systems 433, and items 443 are located at location 453. Locations 452-453 may be different physical locations for a single entity or may be associated with different entities. For instance, locations 452-453 may be two store locations for one business or store locations for different businesses. Video processing system 401 is located remote from locations 452-453, although, in some examples, video processing system 401 may be located at one of locations 452-453 or distributed across locations 452-453. In one example, video processing system 401 is located in a data center (or distributed across data centers) to provide visual identification services from the cloud over network 404, which may include the internet. Locations 452-453 may also include networks for communications between components thereat.

In operation, video cameras 422-423 capture video of areas within respective locations 452-453. At least a portion of video cameras 422-423 capture scanners of scanner systems 432-433 at respective locations 452-453. In some cases, a single video camera may be able to capture multiple scanners or one video camera per scanner may be used. Video cameras 422-423 may be part of security systems at locations 452-453, may be used for customer traffic flow analysis, may be used for inventory monitoring, or may be used for some other purpose—including combinations thereof. In such examples, video cameras 422-423 may already exist at locations 452-453, or a portion of video cameras 422-423 may already exist at locations 452-453, and can be leveraged for use by video processing systems 401-403 for the purposes described below.

In implementation 400, scanner systems 432-433 are checkout systems (e.g., sales registers) where items 442-443 can be scanned for purchase by customers at locations 452-453. Scanner systems 432-433 may be preconfigured to provide item information in response to queries from requesting systems. Thus, video processing systems 402-403 may be able to query scanner systems 432-433 for item information without modifying scanner systems 432-433. In other examples, scanner systems 432-433 may be modified to provide the item information to video processing systems 402-403. For instance, scanner systems 432-433 may be modified to push item information to respective video processing systems 402-403 when an item is scanned, at the end of a transaction including the item, after a period of time (e.g., every hour or day), or on some other schedule.

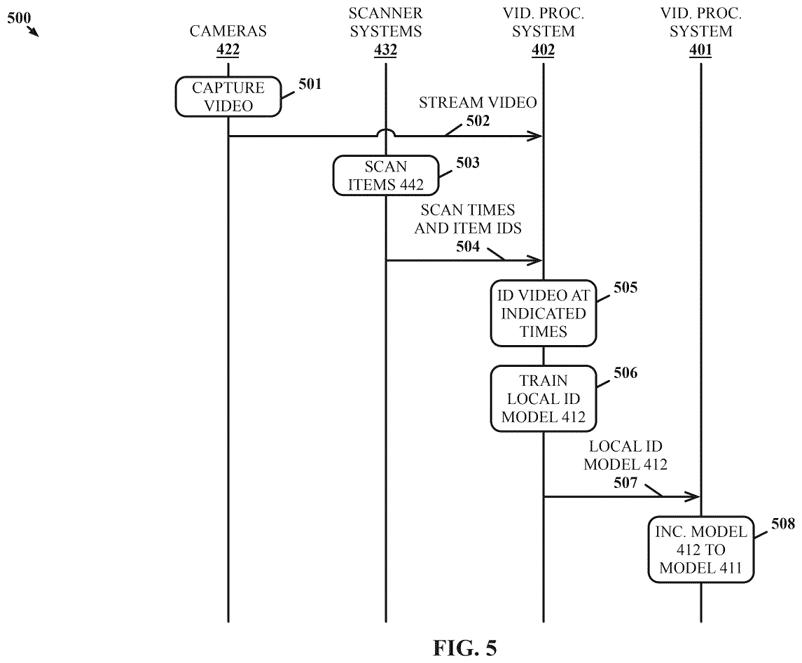

FIG. 5 illustrates operational scenario 500 for identifying an item in an image using a visual identification model trained using scanned information. Operational scenario 500 is described in context of location 452 but similar steps occur at location 453. In operational scenario 500, video cameras 422 are configured to capture video of various areas in location 452 (step 501). Video cameras 422 may be positioned to capture every area of location 452 or specific areas, such as those containing items 442 for purchase. For the purposes of training local visual identification model 412 to identify items 442, at least a portion of video cameras 422 capture at least the scanner portions of scanner systems 432. The captured video is streamed to video processing system 402 (step 502). Portions of the streamed video that is not used for training local visual identification model 412 may be processed by video processing system 402 for other purposes, including feeding through local visual identification model 412 to identify those of items 442 that local visual identification model 412 is already trained to recognize.

While video cameras 422 are streaming the captured video, scanner systems 432 scan items 442 or at least those of items 442 that are being purchased by customers at scanner systems 432 (step 503). Items 442 may be scanned by the customers themselves (e.g., at a self-checkout) and/or by an employee of the business at location 452. Scanner systems 432 transmit identifiers of the items being scanned and timestamps for when the items were scanned to video processing system 402 (step 504). Each of scanner systems 432 may transmit the timestamps and corresponding identifiers in real time as the items are scanned or may transmit the timestamps and identifiers in batches (e.g., periodically or in response to a triggering event such as completion of a transaction). As such, video processing system 402 may buffer, or otherwise store, the streamed video captured of scanner systems 432 at least until scanner systems 432 are due to report item scan times and item identifiers. Video processing system 402 can then delete portions of the received video not associated with any of the received item scan times unless those portions are to be kept for other purposes. Also, video processing system 402 may either track which of scanner systems 432 sent specific sets of scan times and item identifiers or scanner systems 432 may include an identifier for themselves when transmitting scan times and item identifiers. Video processing system 402 may maintain a data structure indicating which of scanner systems 432 are covered by which of video cameras 422 enabling video processing system 402 to determine which video captures which scanner of scanner systems 432.

Video processing system 402 identifies portions of the streamed video corresponding to the scan times received from scanner systems 432 (step 505). For example, if the scan time from one of scanner systems 432 indicates an item of items 442 was scanned at 3:45:23 PM, then video processing system 402 will identify video from a camera of video cameras 422 that captured a scanner of the reporting scanner system. If local visual identification model 412 can process still images, then video processing system 402 may only identify a frame of the video from the camera captured at 3:45:23 PM. Although, if local visual identification model 412 can handle video clips, then video processing system 402 may identify a video clip from the video received from the camera. The video clip may include a range of time that includes 3:45:23 PM (e.g., may include video captured from 3:45:21 to 3:45:25 to capture a couple second before and after the actual scanning occurred). A user scanning the item may change the orientation of the item when picking up the item and moving it to the scanner, which may allow the video clip to capture different angles that can be learned by remote visual identification model 411 to better recognize the item in the future. Video processing system 402 may identify video portions for all of items 442 scanned or may identify video portions for only for a select subset of the scanned items. For example, video processing system 402 may determine that local visual identification model 412 has already been sufficiently trained to recognize certain items of items 442. When scanner systems 432 notify video processing system 402 that one of those items has been scanned, video processing system 402 may ignore that notification for purposes of training local visual identification model 412. Alternatively, video processing system 402 may notify scanner systems 432 when item information is not needed for certain ones of items 442, which instructs scanner systems 432 to stop sending item information for those items when scanned.

Video processing system 402 feeds the identified video portions into local visual identification model 412 to train local visual identification model 412 (step 506). Video processing system 402 includes an identifier for the item that the scanner system indicated is being scanned with each video portion. The identifier may be included as metadata with the corresponding video portion, may be provided as a separate file or value in association with the video portion, or may be provided using some other convention that local visual identification model 412 is configured to handle. Local visual identification model 412 may be trained in real time such that anytime an item is scanned, video processing system 402 receives item information from the scanning system, selects a video portion for the scan time, and feeds the video portion into local visual identification model 412 with an identifier for the item to train local visual identification model 412. In other examples, video processing system 402 may wait to train local visual identification model 412. For instance, video processing system 402 may wait until a store comprising location 452 closes for the day before training local visual identification model 412 based on items scanned that day.

After training local visual identification model 412, video processing system 402 sends a copy of local visual identification model 412 to video processing system 403 (step 507). Video processing system 402 may send the copy every time local visual identification model 412 completes training on a provided video portion or may send the copy on some other schedule (e.g., periodically every hour or day). In some examples, video processing system 402 may send a copy of incremental updates to local visual identification model 412 made since video processing system 402 last sent a copy of local visual identification model 412 to video processing system 401. Video processing system 401 incorporates local visual identification model 412 (or the updates made thereto) into remote visual identification model 411 (step 508). Incorporating, or merging, the copy of local visual identification model 412 into remote visual identification model 411 may also be called ensemble learning, model blending, or model stacking, depending on the mechanism used to merge the two models. Some example mechanisms include using a weighted average when models are combined by assigning different weights to their predictions or outputs and using stacking of the models where predictions from multiple models are used as input features to a meta-model (often a simple classifier or regressor) that learns to combine these predictions optimally. Video processing system 401 may also receive a of local visual identification model 413 from video processing system 403 after video processing system 403 has trained local visual identification model 413 to identify items of items 443 (which may be some of the same items that video processing system 402 trained local visual identification model 412 to identify from items 442). By incorporating local visual identification model 412 and local visual identification model 413 into remote visual identification model 411, remote visual identification model 411 may be able to better identify items because remote visual identification model 411 has the advantage of being trained from video captured at multiple locations. For example, video cameras 423 may have captured an item from different angles than video cameras 422 were able to capture. Thus, local visual identification model 413 may have been trained to recognize different angles of the item than local visual identification model 412 was trained to recognize. Remote visual identification model 411 has the advantage of receiving training angles from both local visual identification model 412 and local visual identification model 413. Thus, if local visual identification model 412 cannot recognize an item, remote visual identification model 411 may be able to help.

In some examples, rather than relying on video processing system 402 to supply a copy of local visual identification model 412, video processing system 401 may train remote visual identification model 411 itself. For instance, in addition to feeding the video portions and item identifiers into local visual identification model 412 for training, video processing system 402 may transmit the portions and identifiers to video processing system 401. Video processing system 401 may then train remote visual identification model 411 by feeding the received video portions and identifiers into remote visual identification model 411 in a manner similar to what video processing system 402 does to train local visual identification model 412. Video processing system 403 may be configured to also supply identified video portions and item identifiers to video processing system 401.

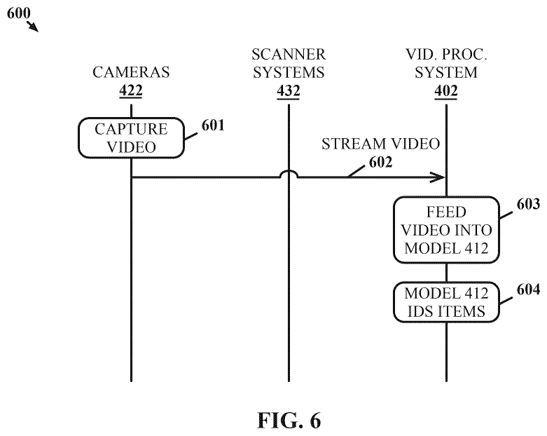

FIG. 6 illustrates operational scenario 600 for identifying an item in an image using a visual identification model trained using scanned information. Like operational scenario 500, operational scenario 600 is described in context of location 452 but similar steps occur at location 453. In operational scenario 600, video cameras 422 capture video of areas of location 452 (step 601). The captured video is streamed to video processing system 402 (step 602). Steps 601-602 may be the same as steps 501-502, as operational scenario 600 may occur in parallel with operational scenario 500. Operational scenario 500 handles training local visual identification model 412 while operational scenario 600 describes how local visual identification model 412 is used to identify items after being trained to do so. The cameras of video cameras 422 providing video in this example may be all of video cameras 422 at location 452 or may be a subset of the cameras. For example, the entity operating location 452 may only care about identifying items on shelves in certain areas of the store (e.g., may not care about items in a café at location 452). In that case, video processing system 402 may only receive, or at least only processes, video from those of video cameras 422 that capture the areas of interest to the entity.

Video processing system 402 feeds the video into local visual identification model 412 (step 603). In response to being fed the video, local visual identification model 412 provides output identifying items in the video (step 604). Local visual identification model 412 may be configured to output which items it recognizes at different times in the input video image, a number of each item it identifies in the video image at different times, where the items are located in the video image at different times, may output movement of the items over time through the video, or may be configured to perform some other analysis dependent on local visual identification model 412′s ability to identify items in the video. In some examples, the output from local visual identification model 412 may be fed into one or more other machine learning models for further analysis.

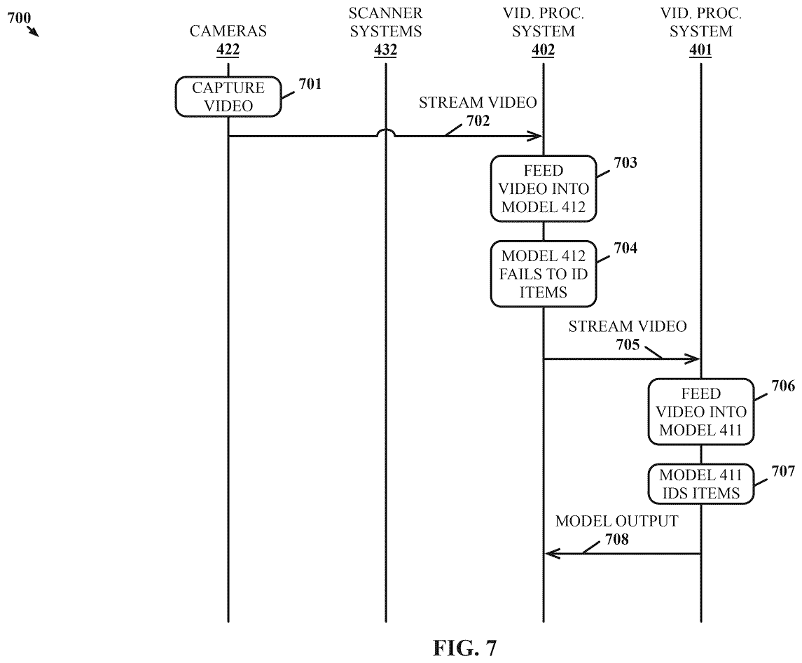

FIG. 7 illustrates operational scenario 700 for identifying an item in an image using a visual identification model trained using scanned information. Operational scenario 700 may be considered an extension of operational scenario 600 involving video processing system 401 to assist video processing system 402. Again, like operational scenarios 500-600, operational scenario 700 is described in context of location 452 but similar steps occur at location 453. Steps 701-703 are substantially similar to steps 601-603. However, output of local visual identification model 412 fails to identify one or more items that were contained in the video images (step 704). Local visual identification model 412 may still provide output like it does in step 604 with items that local visual identification model 412 was able to identify. Video processing system 402 may know local visual identification model 412 was unable to identify at least one item because local visual identification model 412 may indicate in its output that certain objects were found in the images but could not be identified. In other examples, video processing system 402 may assume there may be one or more items that local visual identification model 412 could not identify even if local visual identification model 412 is unable to recognize that fact.

Video processing system 402 streams the video that was input into local visual identification model 412 at step 703 to video processing system 401 (step 705). All of the video may be sent or just a portion of the video that includes items local visual identification model 412 could not identify if local visual identification model 412 is capable of making that determination. In some cases, when the output of local visual identification model 412 does not affect what video is sent to video processing system 401, video processing system 402 may send the video to video processing system 401 immediately upon receipt from video cameras 422 or video cameras 422 may be configured to send the video to video processing system 401 directly. Video processing system 401 feeds the received video into remote visual identification model 411 (step 706). Remote visual identification model 411 is configured to provide similar output to local visual identification model 412 identifying items from the video (step 707). In this case, the output may identify items that local visual identification model 412 was unable to identify in its output. For example, since remote visual identification model 411 was trained from location 453 in addition to local visual identification model 412, remote visual identification model 411 may be trained to identify items that local visual identification model 412 has yet to be trained on (e.g., location 453 may stock a particular item before location 452) or may have trained on different angles of an item than local visual identification model 412 was trained on.

Video processing system 401 reports the output of remote visual identification model 411 to video processing system 402 (step 708). Upon receiving the output from video processing system 401, video processing system 402 can factor the conclusions of remote visual identification model 411 into any tasks video processing system 402 performs with model output. The output from video processing system 401 may only include additional items the remote visual identification model 411 identified or, in some cases, the output may include items already identified by local visual identification model 412. In the latter example, video processing system 402 may replace the output from local visual identification model 412 with the output received from video processing system 401 when performing additional tasks (e.g., presenting output to a user, performing product sales analysis, etc.).

In some examples, the item identification load may be shared differently than is described in operational scenario 700. For example, while local visual identification model 412 was trained from items being scanned at location 452, portions of local visual identification model 412 may be offloaded for incorporation into remote visual identification model 411. Video processing system 402 may run on relatively inexpensive computing hardware, such as a consumer grade desktop computer, while video processing system 401 may be a high-powered server system. Thus, video processing system 402 may only be able to handle a small portion of what local visual identification model 412 is trained to do. As such, components of local visual identification model 412 may be offloaded to video processing system 401 for incorporation into remote visual identification model 411. For instance, video processing system 402 may keep a portion of local visual identification model 412 that identifies some of the most popular items, or items that are of most interest to the entity running location 452, for local identification from video while offloading other portions of local visual identification model 412 for inclusion in remote visual identification model 411. In some examples, video processing system 402 may also offload training to video processing system 401 in operational scenario 500.

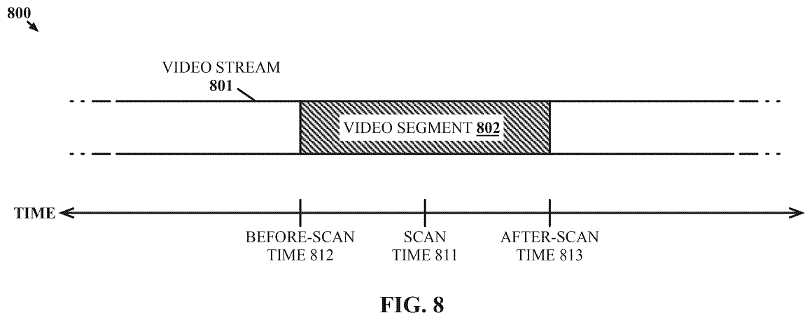

FIG. 8 illustrates timeline 800 for identifying an item in an image using a visual identification model trained using scanned information. Timeline 800 is an example of how image processing system 101 or video processing systems 401-403 may identify a portion of video for training visual identification model. In this example, video stream 801 is video received from a video camera (e.g., one of video cameras 422). A scanner system (e.g., one of scanner systems 432) indicates that an item was scanned at scan time 811. In some examples, a frame of video stream 801 captured at scan time 811 may be selected to train the model. Although, in this example, video segment 802 is a clip that is selected to use for training. Video segment 802 is a clip that includes scan time 811 but begins at before-scan time 812 and after-scan time 813. For instance, before-scan time 812 may be a second or two prior to scan time 811 and after-scan time 813 may be a second or two after scan time 811. Using a clip like video segment 802 rather than a still image enables the model to be trained on additional angles and orientations of the product being scanned.

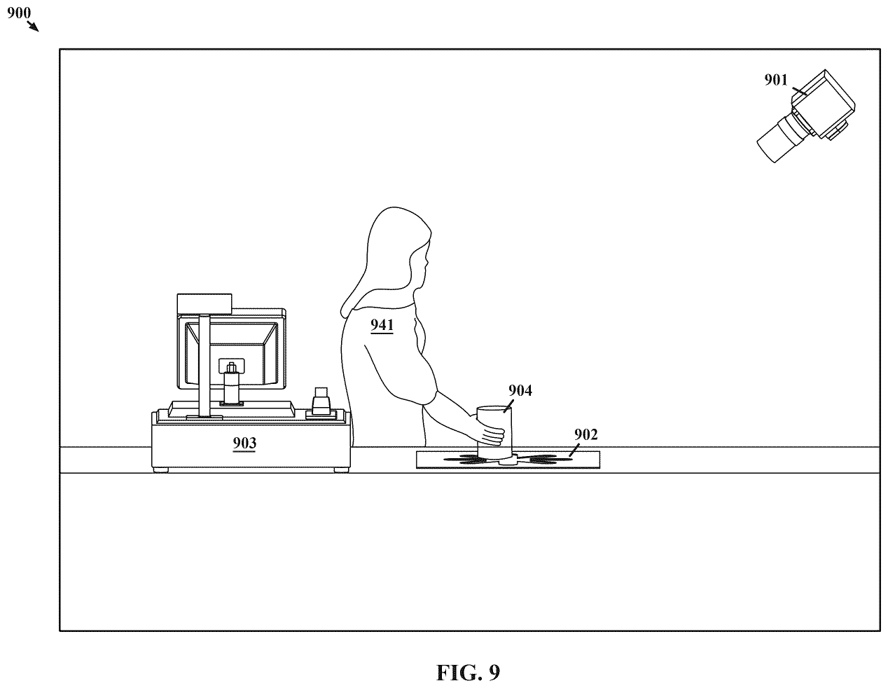

FIG. 9 illustrates location 900 for identifying an item in an image using a visual identification model trained using scanned information. Location 900 is an area of a store having a checkout station that includes sales register 903 and scanner 902 connected thereto. Scanner 902 is an in-counter barcode scanner, but different types of scanners may be used in other examples. Sales register 903 and scanner 902 may be part of scanner system 103, scanner systems 432, or scanner systems 433. Video camera 901 is positioned to at least capture items being scanned by scanner 902. In this example, item 904 is positioned over scanner 902 by user 941 to scan item 904 into sales register 903. User 941 may be an employee working at location 900 to checkout items on behalf of a customer or user 941 may be a customer with sales register 903 and scanner 902 operating as a self-checkout station.

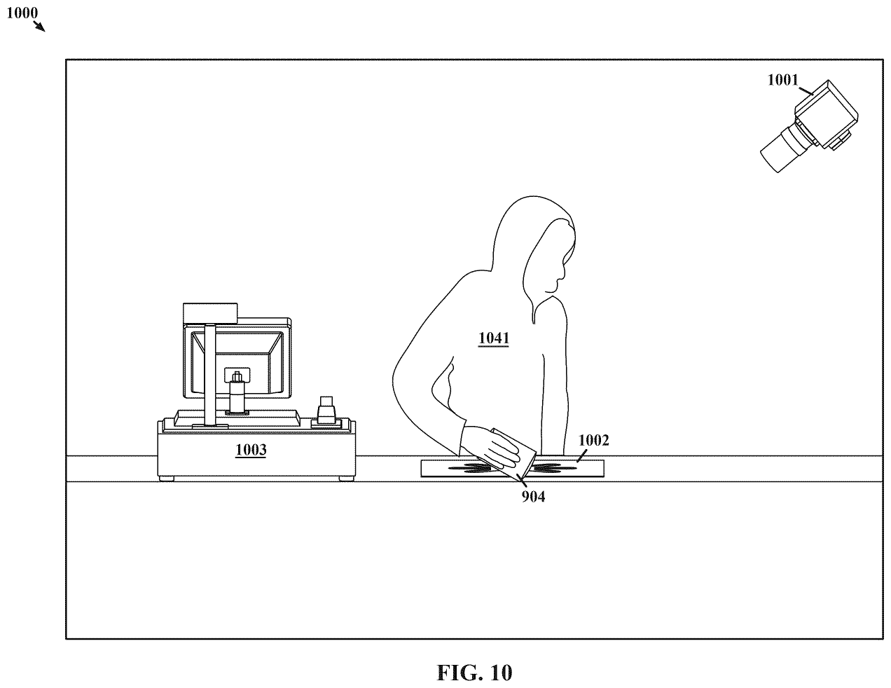

FIG. 10 illustrates location 1000 for identifying an item in an image using a visual identification model trained using scanned information. Location 1000 may be the same location as location 900 but shown at a different time or location 1000 may be a different location having a similar setup to location 900. As such, sales register sales register 1003 may be sales register 903, scanner 1002 may be scanner 902, and video camera 1001 may be video camera 901. In this example, user 1041 is a different user than user 941 who is positioning item 904 over scanner 1002 to scan item 904 into sales register 903. When comparing location 1000 to location 900, user 1041 is passing item 904 over scanner 1002 at a different angle relative to video camera 1001, which may increase the accuracy of a visual identification model when images captured by video camera 901 and video camera 1001 are used to train the model to identify item 904 in video.

It should be understood that item 904 in location 900 and location 1000 are not the exact same object but, rather, are instances of the same object. For example, item 904 may be a can of corn from a particular brand. A single store may have multiple instances of item 904 in their inventory and item 904 may be sold at different store locations. When a model is trained to identify item 904, it is trained to identify all instances of item 904 that may be captured in video fed into the model for processing.

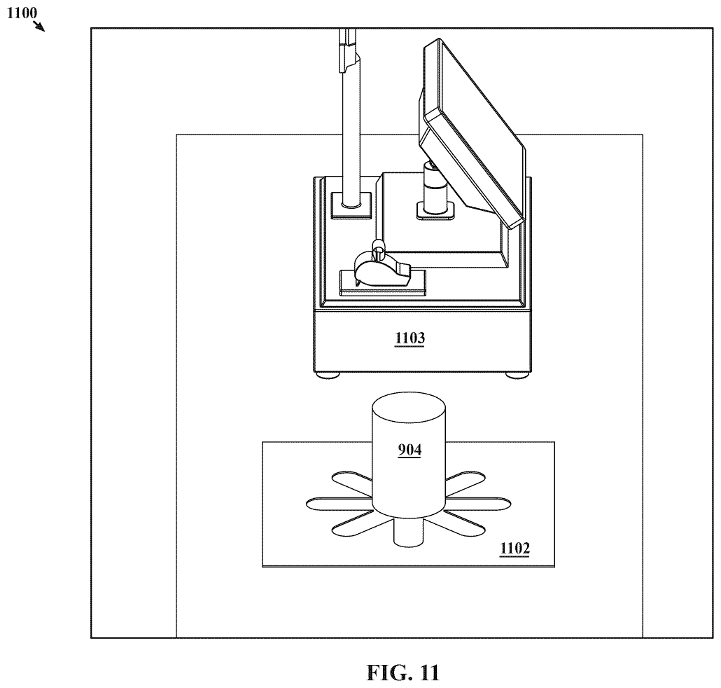

FIG. 11 illustrates video frame 1100 for identifying an item in an image using a visual identification model trained using scanned information. Video frame 1100 is an example view captured from video camera 901 or video camera 1001. As such, sales register 1103 may be sales register 903 or sales register 1003 and scanner 1102 may be scanner 902 or scanner 1002. Item 904 is shown positioned over scanner 1102 being scanned. A user is not shown for clarity but it should be understood that a user may be holding item 904 in the position over scanner 1102.

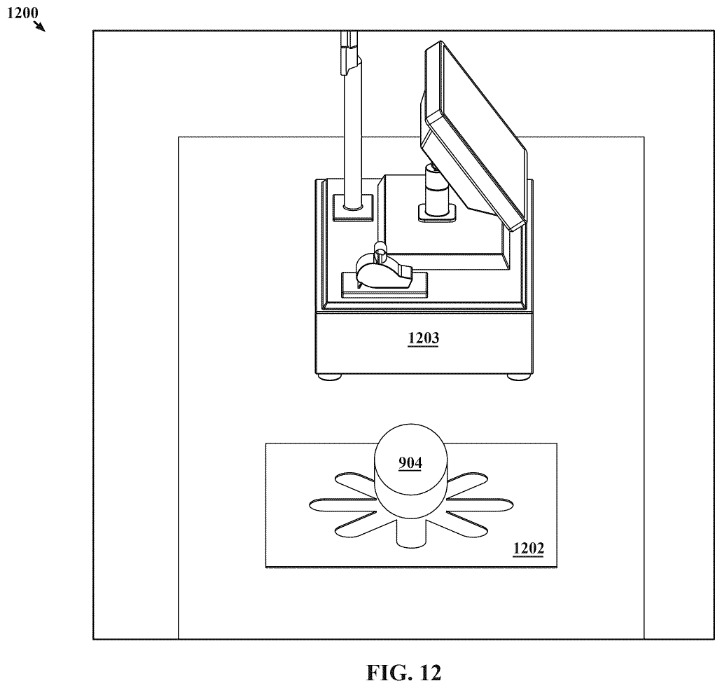

FIG. 12 illustrates video frame 1200 for identifying an item in an image using a visual identification model trained using scanned information. Video frame 1200 shows a similar view to that shown in video frame 1100. Video frame 1200 may be captured from the same camera as video frame 1100. Sales register 1203 may be sales register 903 or sales register 1003 and scanner 1202 may be scanner 902 or scanner 1002. Item 904 in this case is positioned over scanner 1202 in a different orientation relative to the camera capturing video frame 1200. If both video frame 1100 and video frame 1200 are used to train a visual identification model, the model is provided with more information about how item 904 looks from different angles since it is likely that item 904 will have different orientations in future images that the model will be called upon to process.

While the camera capturing video frame 1200 captures video from a similar angle as the camera capturing video frame 1100, other examples may capture scanner 1202 from different angles. In one example, the camera may be built into sales register 1203 and pointed at scanner 1202 from sales register 1203.

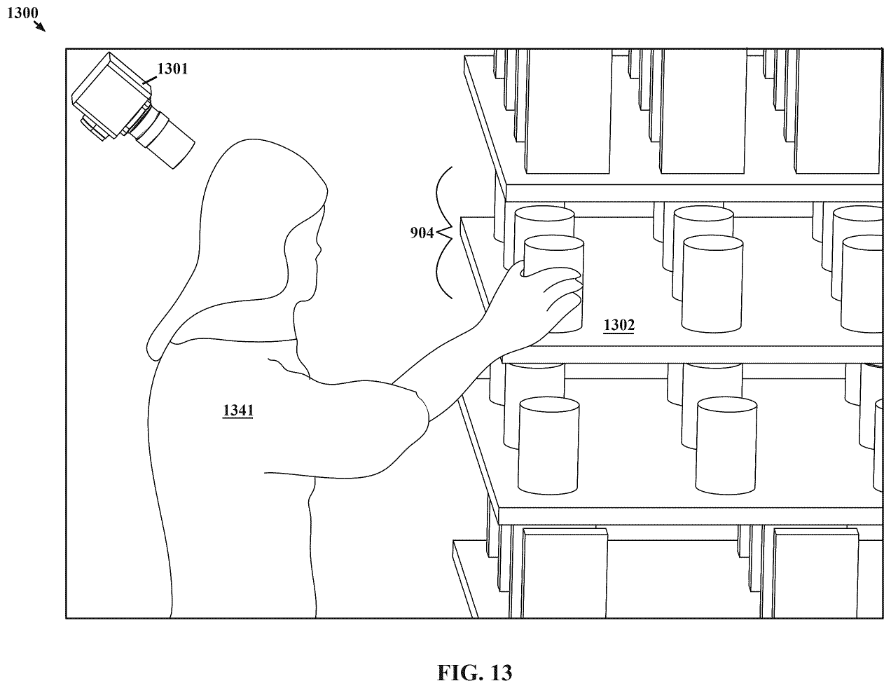

FIG. 13 illustrates location 1300 for identifying an item in an image using a visual identification model trained using scanned information. Location 1300 is an area of a retail store away from the scanner systems that is shown being captured by video camera 1301. Although, in some examples, video camera 1301 may still capture at least a portion of a scanner system arca. Location 1300 may be at the same store as either or both of location 900 and location 1000 or may be a different store. Video camera 1301 is pointed at shelving that includes shelf 1302 with many instances of item 904 located thereon. A visual identification model may have already been trained to recognize item 904 using images such as video frame 1100 and video frame 1200. As such, when video captured by video camera 1301 is fed into the visual identification model, the visual identification model may output that shelf 1302 contains many of item 904 and, for example, may include a count of the number of instances of item 904 that can be seen from the perspective of video camera 1301. Likewise, as user 1341 grabs one of user 1341, the model may recognize that user 1341 grabbed item 904 rather than some other item, such as the similarly shaped items on the shelf below. The identification is all performed by the model without a user having to manually create a training set for the model since information gathered from scanner systems is used instead.

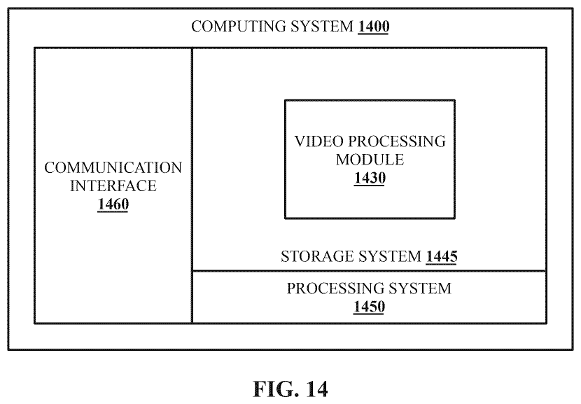

FIG. 14 illustrates a computing system 1400 for identifying an item in an image using a visual identification model trained using scanned information. Computing system 1400 is representative of any computing system or systems with which the various operational architectures, processes, scenarios, and sequences disclosed herein can be implemented. Computing system 1400 is an example architecture for image processing system 101 and video processing systems 401-403, although other examples may exist. Computing system 1400 includes storage system 1445, processing system 1450, and communication interface 1460. Processing system 1450 is operatively linked to communication interface 1460 and storage system 1445. Communication interface 1460 may be communicatively linked to storage system 1445 in some implementations. Computing system 1400 may further include other components such as a battery and enclosure that are not shown for clarity.

Communication interface 1460 comprises components that communicate over communication links, such as network cards, ports, radio frequency (RF), processing circuitry and software, or some other communication devices. Communication interface 1460 may be configured to communicate over metallic, wireless, or optical links. Communication interface 1460 may be configured to use Time Division Multiplex (TDM), Internet Protocol (IP), Ethernet, optical networking, wireless protocols, communication signaling, or some other communication format—including combinations thereof. Communication interface 1460 may be configured to communicate with other computing systems via one or more networks.

Processing system 1450 comprises microprocessor and other circuitry that retrieves and executes operating software from storage system 1445. Storage system 1445 may include volatile and nonvolatile, removable, and non-removable media implemented in any method or technology for storage of information, such as computer readable instructions, data structures, program modules, or other data. Storage system 1445 may be implemented as a single storage device but may also be implemented across multiple storage devices or sub-systems. Storage system 1445 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1445, or any other computer-readable storage medium herein, be considered a transitory form of signal transmission (often referred to as “signals per se”), such as a propagating electrical or electromagnetic signal or carrier wave.

Processing system 1450 is typically mounted on a circuit board that may also hold the storage system. The operating software of storage system 1445 comprises computer programs, firmware, or some other form of machine-readable program instructions. The operating software of storage system 1445 comprises video processing module 1430. The operating software on storage system 1445 may further include an operating system, utilities, drivers, network interfaces, applications, or some other type of software. When read and executed by processing system 1450 the operating software on storage system 1445 directs computing system 1400 to network routing advertisements as described herein. Video processing module 1430 may execute natively on processing system 1450 or the operating software may include virtualization software, such as a hypervisor, to virtualize computing hardware on which video processing module 1430 executes.

In at least one example, video processing module 1430 executes on processing system 1450 and directs processing system 1450 to receive an image captured at a capture time of a checkout space including a scanner system and receive an indication that an item has been scanned by the scanner system. The indication includes an identity of the item and identifies a scan time when the item was scanned. Video processing module 1430 further directs processing system 1450 to correlate the scan time with the capture time and provide the image and the identity of the item to a visual identification model to train the visual identification model to identify the item from other images. The visual identification model may be included in video processing module 1430 or may be separate therefrom.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for training a model to visually identify items, the method comprising:
receiving an image captured at a capture time of a checkout space including a scanner system;
receiving an indication that an item has been scanned by the scanner system, wherein the indication includes an identity of the item and identifies a scan time when the item was scanned;
correlating the scan time with the capture time; and
providing the image and the identity of the item to a visual identification model to train the visual identification model to identify the item from other images.

2. The method of claim 1, comprising:
receiving a second image captured of a different space from the checkout space;
feeding the second image to the visual identification model; and
receiving output from the visual identification model, wherein the output identifies the item in the second image.

3. The method of claim 2, wherein the checkout space and the different space are collocated at a location of an entity.

4. The method of claim 2, wherein the checkout space is at a first location of a first entity and the different space is located at a second location of a second entity.

5. The method of claim 1, comprising:
receiving a second image captured at a second capture time of the checkout space including the scanner system;
receiving a second indication that the item has been scanned by the scanner system, wherein the second indication includes the identity of the item and identifies a second scan time when the item was scanned;
correlating the second scan time with the second capture time; and
providing the second image and the identity of the item to the visual identification model to train the visual identification model to identify the item from the other images.

6. The method of claim 5, wherein the second image captures the item from an angel not captured in the image.

7. The method of claim 1, comprising:
receiving a second image captured at a second capture time of a second space including a second scanner system;
receiving a second indication that the item has been scanned by the second scanner system, wherein the second indication includes the identity of the item and identifies a second scan time when the item was scanned;
correlating the second scan time with the second capture time; and
providing the second image and the identity of the item to the visual identification model to train the visual identification model to identify the item from the other images.

8. The method of claim 1, comprising:
cropping portions of the image other than the item before providing the image to the visual identification model.

9. The method of claim 1, wherein the image is a video, and the method comprising:
determining a time frame including the scan time in which the item can be seen in the video.

10. The method of claim 1, comprising:
receiving a second image captured of a retail space displaying a plurality of items; and
feeding the second image into the visual identification model, wherein the visual identification model provides output identifying at least one instance of the item in the second image.

11. The method of claim 10, wherein the visual identification model is also trained to identify a second item of the plurality of items and wherein the output also identifies at least one instance of the second item in the second image.

12. The method of claim 10, wherein the second image is a video image, the method comprising:
determining a first instance of the at least one instance is absent from the video image at a second time; and
decrementing an inventory of the item by one.

13. The method of claim 12, comprising:
identifying a customer in the video image; and
determining the customer removed the first instance from the retail space.

14. A method for training a model to visually identify items, the method comprising:
receiving images captured by a plurality of cameras directed towards a plurality of checkout spaces including a plurality of checkout scanners;
identifying items being scanned in the images from scan information received from the plurality of checkout scanners when the items are scanned; and
training a visual identification model to identify the items from subsequent images.

15. The method of claim 14, comprising:
receiving the subsequent images from a second plurality of cameras;
inputting the subsequent images into the visual identification model; and
receiving output from the visual identification model identifying at least one of the items in subsequent images.

16. The method of claim 14, wherein receiving the images comprises:
receiving the images over a communication network from premises equipment at a plurality of locations having the plurality of checkout spaces.

17. The method of claim 14, comprising:
in a camera connected to premises equipment at a location, capturing an image of the subsequent images;
in the premises equipment, inputting the image into a portion of the visual identification model and transmitting the image over a communication network to a remote processing system;
in the remote processing system, inputting the image into a different portion of the visual identification model; and
receiving output from the visual identification model identifying at least one of the items in the image.

18. The method of claim 17, wherein the image is transmitted in response to the portion of the visual identification model failing to indicate an item in the image.

19. The method of claim 17, wherein the portion of the visual identification model comprises an instance of the visual identification model trained from a portion of the images captured by a portion of the plurality of cameras at the location.

20. An apparatus for training a model to visually identify items, the apparatus comprising:
one or more computer readable storage media;
a processing system operatively coupled with the one or more computer readable storage media; and
program instructions stored on the one or more computer readable storage media that, when read and executed by the processing system, direct the apparatus to:
receive an image captured at a capture time of a checkout space including a scanner system;
receive an indication that an item has been scanned by the scanner system, wherein the indication includes an identity of the item and identifies a scan time when the item was scanned;
correlate the scan time with the capture time; and
provide the image and the identity of the item to a visual identification model to train the visual identification model to identify the item from other images.
